(19) United States
(12) Patent Application Publication
(10) Pub. No.: US 2006/0157536 A1
(43) Pub. Date: Jul. 20, 2006

(54) Work piece holder

(75) Inventors: Edwin Wolf, Marian del Ray, CA (US); Ronald L. Dick, Boston Heights, OH (US); Frank P. Mends, Maple Heights, OH (US)

Correspondence Address: CALFEE HALTER & GRISWOLD, LLP, 800 SUPERIOR AVENUE, SUITE 1400, CLEVELAND, OH, 44114, US

(73) Assignee: WORK PIECE HOLDER

(21) Appl. No.: 11/313,894

(22) Filed: Dec. 21, 2005

Related U.S. Application Data
(60) Provisional application No. 60/639,418, filed on Dec. 27, 2004.

(51) Int. Cl. A47J 36/02

(52) U.S. Cl. 228/101

(57) ABSTRACT

The invention relates to a fixture that reduces the heat transfer between a thermally conductive work piece, such as a copper tube, and the fixture. In one embodiment, the fixture includes a pair of collet members, with each collet member having at least one work piece engaging protrusion, and a clamping mechanism that urges the collet members toward each other to engage and clamp the work piece between the collet members. The contact between the work piece and the protrusions of the collet members inhibit additional surface contract between the work piece and the fixture, reducing the heat transfer from the work piece to the fixture during welding.

### RELATED APPLICATIONS

The present application claims priority from United States provisional application serial No. 60/639,418, entitled “Collet for Cylindrical Work Pieces,” filed on Dec. 28, 2004. U.S. provisional application serial No. 60/639,418 is incorporated herein by reference in its entirety.

### FIELD OF THE INVENTION

The present invention relates to work piece holders. More particularly, the present invention relates to a fixture for holding cylindrical work pieces with high thermal conductivity.

### BACKGROUND OF THE INVENTION

U.S. Pat. No. 4,379,215, issued Apr. 5, 1983, for “Orbital Cassette Welding Head,” discloses an apparatus for welding abutting tube sections. The apparatus includes an orbital welding head unit and a separate U-shaped tube clamp unit which holds the tube sections to be welded in abutting aligned relationship during the orbiting of the weld head about the tube ends. The tube clamp unit uses rigid collets to hold the tube sections in alignment during the welding operation. U.S. Pat. No. 4,379,215 is incorporated herein by reference in its entirety.

U.S. Pat. No. 4,868,367, issued Sep. 19, 1989, for “Rigid collet assembly for cylindrical work pieces,” discloses a clamping device that includes opposed clamp halves each having a collet face adapted to be moved toward and away from one another. Each of the clamp halves carry a rigid collet member adapted to engage on opposite sides of cylindrical work pieces when the clamp halves are moved toward one another. U.S. Pat. No. 4,868,367 is incorporated herein by reference in its entirety.

### SUMMARY OF THE INVENTION

The invention contemplates fixturing that reduces the heat transfer between a thermally conductive work piece, such as a copper tube, and a fixture during an application that applies extreme temperatures to the work piece, such as an orbital welding operation. By reducing the heat transfer between the fixture and the work piece, the amount of energy required to heat or weld the work piece, or to maintain the heated temperature of the work piece, may be reduced. This reduction in heat transfer may be accomplished by reducing the surface contact between the work piece and the fixture. The surface contact between the work piece and the fixture may be reduced by providing one or more discrete protrusions on the fixture to engage the work piece and limit further contact between the work piece and the fixture. Use of such protrusions may also provide gaps between the work piece and the fixture, which may be used to vent purge gas from around the outer surfaces of the work piece, as is used during welding operations. Alternatively or additionally, a reduction in heat transfer may be accomplished by reducing the mass of one or more fixture components in contact with the work piece, to reduce the amount of material that may absorb heat from the work piece.

In one embodiment, the fixture includes a pair of collet members, with each collet member having at least one work piece engaging protrusion, and a holding mechanism that urges the collet members toward each other to engage and hold the work piece between the collet members. The contact between the work piece and the protrusions of the collet members reduce or minimize surface contact between the work piece and the fixture, reducing the heat transfer from the work piece to the fixture during welding. In one embodiment, the work piece may be held between the collet members by a clamping action.

In another embodiment of the invention, a welding system or assembly includes a welder and a fixture having a collet member, with the collet member having at least one work piece engaging protrusion for engaging a work piece to hold the work piece in the fixture.

In another embodiment of the invention, a method of clamping a cylindrical work piece includes the steps of placing the work piece between the body of a first collet member and the body of a second collet member, and urging the first collet member toward the second collet member, causing at least one protrusion on the first collet member and at least one protrusion on the second collet member to engage the work piece and hold the work piece between the two collet members. In yet another embodiment of the invention a method of welding a cylindrical work piece involves placing the work piece between a first and second collet member, urging the first collet member toward the second collet member such that at least one protrusion defined by the first collet member and at least one protrusion defined by the second collet member engage and hold the work piece, applying an inert gas to the work piece, wherein a portion of the inert gas flows through gaps between the protrusions, and welding the work piece.

In yet another embodiment of the invention, a collet member for holding a cylindrical thermally conductive work piece includes a body that defines a work piece opening and a work piece engaging surface for engaging the work piece when the work piece is disposed in the work piece opening. The collet member may include one or more hollow regions defined by the body, which reduce the mass of the collet member.

Further advantages and benefits will become apparent to those skilled in the art after considering the following description and appended claims in conjunction with the accompanying drawings.

### BRIEF DESCRIPTION OF THE DRAWINGS

FIG. 1A is a perspective view of a fixture for holding a cylindrical work piece;

FIG. 1B is a side view of the fixture of FIG. 1A, as used in an orbital welding application;

FIG. 2 is an elevational view taken along the plane indicated by lines line 2-2 of FIG. 1A;

FIG. 3 is an end view of a collet member;

FIG. 4 is a partial elevational view, somewhat diagrammatic, showing collet members in engagement with a tubing whose outer diameter is at a maximum within its tolerance range;

FIG. 5 is a partial elevational view, somewhat diagrammatic, showing collet members in engagement with a tubing whose outer diameter is at a minimum within its tolerance range;

FIG. 6 is a perspective view of a collet member;

FIG. 7 is a view taken along the plane indicated by lines 7-7 in FIG. 6;

FIG. 8 is a view taken along the plane indicated by lines 8-8 in FIG. 7;

FIG. 9 is a view taken along the plane indicated by lines 9-9 in FIG. 7;

FIG. 10 is a view taken along the plane indicated by lines 10-10 in FIG. 7;

FIG. 11 is a view taken along the plane indicated by lines 11-11 in FIG. 7;

FIG. 12 is a view taken along the plane indicated by lines 12-12 in FIG. 8.

### DETAILED DESCRIPTION

The present invention provides for reducing surface contact and heat transfer between a work piece and a work piece holder, such as a fixture, during welding operations. By reducing the heat transfer between the fixture and the work piece, the amount of energy required to heat or weld the work piece, or to maintain the heated temperature of the work piece, may be reduced. This reduction in heat transfer may be accomplished by reducing the surface contact between the work piece and the fixture. The surface contact between the work piece and the fixture may be reduced by providing one or more discrete protrusions on the fixture to engage the work piece and limit further contact between the work piece and the fixture. Use of such protrusions may also provide gaps between the work piece and the fixture, which may be used to vent purge gas from around the outer surfaces of the work piece, as is used during welding operations. Alternatively or additionally, a reduction in heat transfer may be accomplished by reducing the mass of one or more fixture components in contact with the work piece, to reduce the amount of material that may absorb heat from the work piece.

In one embodiment, a fixture 10 that reduces the heat transfer between a thermally conductive work piece 60 (FIGS. 4 and 5), such as a copper tube, and the fixture 10, as compared to existing welding fixtures. By reducing the heat transfer between the fixture 10 and the work piece 60, the amount of energy required to weld the work piece is reduced. The exemplary fixture reduces the contact area between the fixture 10 and the work piece 60 and/or has a reduced mass, compared to existing welding fixtures, to reduce the heat transfer from the work piece to the fixture.

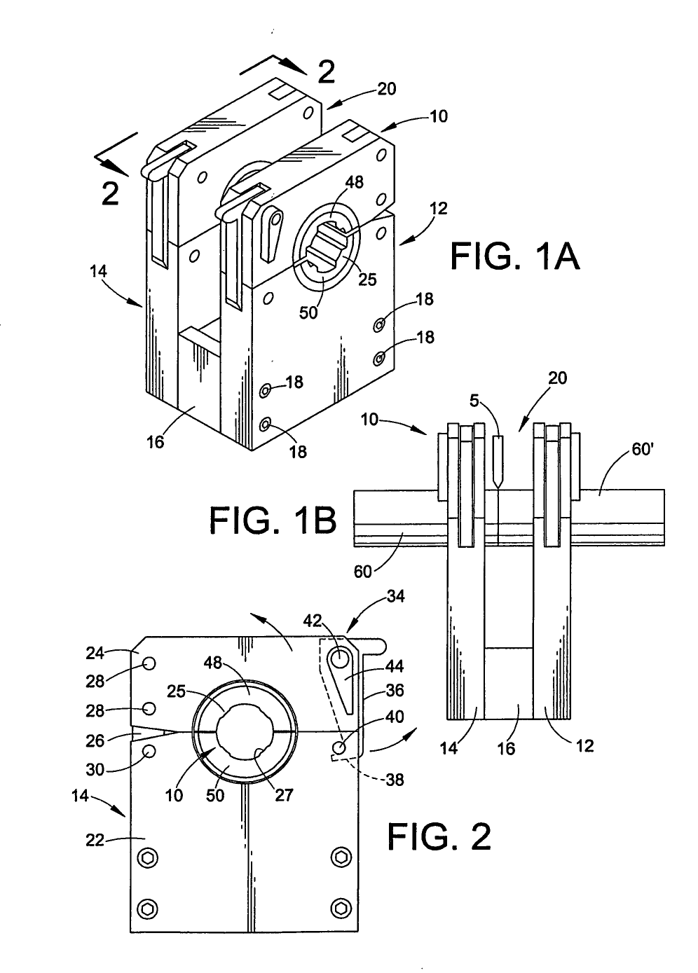

Referring more particularly to the drawings wherein the showings are for the purpose of illustrating an exemplary embodiment of the invention only, and not for the purpose of limiting same, FIGS. 1A and 1B show a cylindrical work piece fixture 10 which may be used for example with an orbital cassette welding head assembly 5, shown schematically in FIG. 1B, of the type generally shown and described in U.S. Pat. No. 4,379,215 of Apr. 5, 1983. The assembly 10 is designed to hold two work pieces 60, 60′, such as, for example, two tubing sections, in aligned relationship with their facing ends generally abutting so that an orbital welding head 5 can rotate about the mating tube ends to perform a butt weld operation. The disclosure of U.S. Pat. No. 4,379,215 is incorporated herein by reference and reference should be had thereto for a more complete description of the welding cassette and its relationship to the assembly 10. The invention may be used with other welding systems, including other welding heads and other fixtures or clamping assemblies.

The cylindrical work piece fixture 10 broadly includes a pair of clamping units 12 and 14 which are joined to the opposite sides of an intermediate spacer member 16. The various components of an exemplary embodiment are formed from stainless steel, aluminum, or the like and the clamp units 12 and 14 are removably joined to the spacer block 16 in any convenient manner such as through the use of machine screws 18. The clamp units 12 and 14 are joined to the spacer member 16 to form a somewhat U-shaped structure with the open center section 20 adapted to receive the orbital welding cassette 5 which carries and drives the welding electrode in a manner more fully described in the aforementioned U.S. patent. Other types of fixtures or clamping assemblies may be used.

In the exemplary embodiment, the clamping units 12 and 14 may be but need not be of generally identical construction except that typically they are mirror images of one another. Accordingly, a description of the clamp unit 14 may be taken as equally applicable to unit 12 unless otherwise noted. However, the clamping units 12 and 14 need not be identical and in one embodiment, only one clamping unit is included (not shown). As best shown in FIG. 2, the clamp unit 14 comprises a pair of opposed clamp halves 22 and 24. Each of the clamp halves 22 and 24 has a rigid, solid construction and are joined by hinge means which permit the clamp halves to be moved toward and away from one another. Specifically, in the subject embodiment, the clamp halves 22 and 24 are joined by a hinge plate 26 which is fixed to the upper clamp half 24 by a pair of pins or the like 28. The lower end of the hinge plate 26 is suitably received in a slot in the lower half 22 and is pivotally connected thereto by a hinge pin 30.

Referring to FIG. 2, the two clamp halves 22 and 24 are releasably connected in their engaged or clamping position by a releasable latch or lock assembly 34. Many different types of lock assemblies could be provided. In the exemplary embodiment, the lock assembly 34 includes a swinging hook element 36 which is pivoted to the upper clamp half 24 and has a hook portion 38 which engages a transverse pin 40 as shown in FIG. 2. An eccentric pivot pin 42 extends through the upper end of the hook member 36 and is rotated through an external lever 44. By rotating the hook plate 36 to the dotted line position shown in FIG. 2 and rotating the eccentric 42, the hook portion 38 is caused to tightly engage the pin 40 and pull the two clamp halves tightly together. However, the present invention is not limited to the clamping mechanism described above, as the fixture 10 may utilize any manner of clamping or closing mechanism, employing one or more of any type of hooks, clamps, latches, fasteners, or the like, as is known or used in the art.

Each of the clamp halves 22 and 24 carries a collet member, which may be a rigid collet member, with the collet members 48, 50 defining contact protrusions 25. The contact protrusions 25 define work piece clamping, engaging or gripping surfaces 27. These surfaces 27 may be contoured so as to correspond with the profile of the mating work piece surface, to provide more uniform contact with the work piece 60, as shown in FIGS. 4 and 5. It should be noted, however, that due to varying tolerances in the outer surface of the work piece 60 and the gripping surfaces 27, the work piece 60 may not fully contact the contact protrusions 25 across the entire gripping surface 27. Where the outer diameter of the work piece 60 is smaller than the diameter of the arcuate gripping surface 27, only a portion of the gripping surface 27 will contact the work piece 60. Under some conditions, such as where the work piece material has a relatively high coefficient of thermal expansion, expansion of the work piece 60 during a welding operation may cause the gripping surface 27 to more fully contact the work piece 60, potentially resulting in a work piece outer diameter that exceeds the diameter of the gripping surface 27. As such, it may be desirable to provide a blended radius or a similar smooth transition at the edges of the gripping surface 27, to minimize gouging of the work piece 60 when the work piece 60 expands during a welding operation, or for any circumstances in which the work piece diameter may be larger than the gripping surface diameter. When the collet members 48, 50 are urged together around a work piece 60 by the clamp halves 22, 24, the contact protrusions 25 engage the work piece 60 in discrete, isolated locations or regions, holding the work piece 60 in a fixed position while minimizing contact between the work piece 60 and the fixture 10. In the exemplary embodiment illustrated by FIGS. 2 and 6-12, separate, identical rigid collet members 48 and 50 are releasably carried in the clamp halves 22, 24 respectively. However, the collet members 48, 50 need not be rigid, separate or identical. For example one collet member may have one protrusion and the second collet member may include two protrusions. The collet members may be releasably connected to their respective clamp halves by fasteners, such as socket head machine screws.

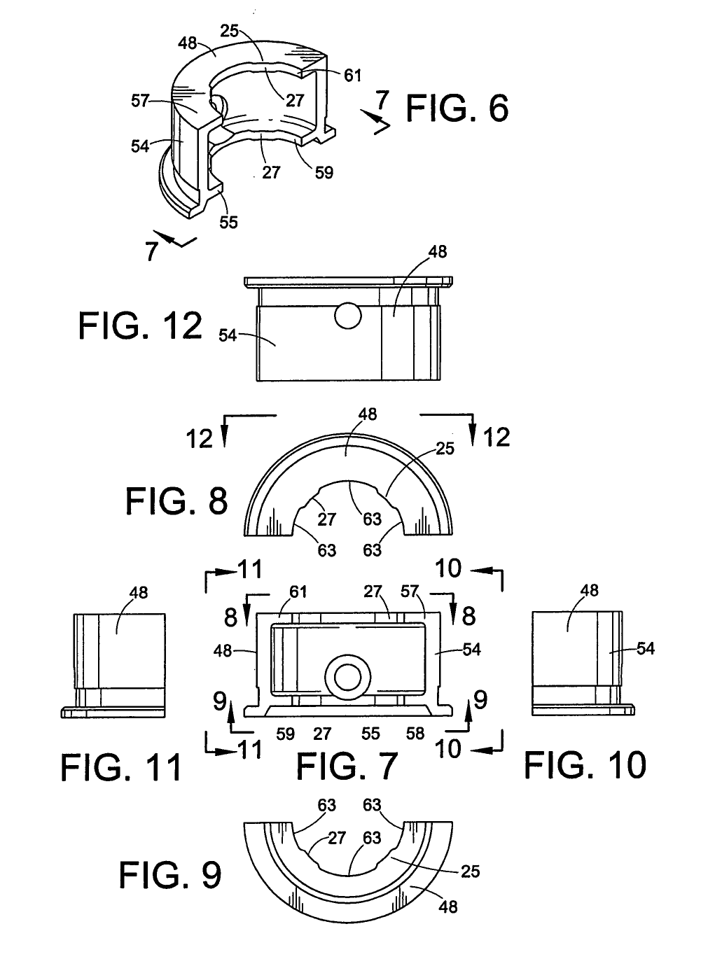

In accordance with another aspect of the invention, the collet members may have a wide variety of different shapes. By way of example, FIGS. 6-12 illustrate a collet member 48 that comprises a generally semi-cylindrical rigid body 54 that defines the contact protrusions 25. The present invention is not limited to the example illustrated by FIGS. 6-12. In the illustrated embodiment, a large portion of material between first and second end faces 55, 57 of the body 54 is removed or absent, such that the body 54 is a substantially hollow structure. Likewise, the collet members of FIGS. 1A-5 may also utilize this type of hollow structure embodiment (not shown). The hollow structure has a much lower capacity to absorb heat from the work piece, as compared to a solid body. The removal or omission of material defines first and second end walls 59, 61. In the illustrated embodiment, two contact protrusions 25 are defined by each wall 59, 61. However, it is contemplated that a differing number of contact protrusions 25 may be provided on either or both of the end walls 59, 61. The contact protrusions 25 are separated by undercuts 63. The two sets of contact protrusions 25 on the first and second end walls 59, 61 engage the work piece 60 in the fixture for welding to a second work piece, positioning the work piece end to be welded in the open section 20 of the fixture 10, according to the exemplary embodiment shown in FIG. 1. The contact protrusions provide angular alignment, offset alignment, adequate grip force on the tubing, and serve as electrically conductive paths between the work piece 60 and the fixture 10 in the exemplary embodiment. In the exemplary embodiment, the contact protrusions include feathered edges. The feathered edges blend and limit contact impressions that result from clamping forces and work piece expansion during the weld process. Referring to FIGS. 4 and 5, the undercuts 63 define small purge air gaps 65 when a work piece 60, such as a tube, is secured between the collet members. The purge air gaps allow air to be displaced by an inert gas in the welding process. A portion of the inert gas will flow through the gaps. The dimensions of the undercuts 63 are selected to maintain a strong inert environment at the welding zone, while minimizing collet contact area with the tubing. Minimizing or reducing or inhibiting collet contact with the tubing limits heat transfer from the tubing through the collet members 48, 50 and, as a result, through the fixture 10. The reduced heat transfer by the illustrated collet members 48, 50 provides a larger heat affected zone in thermally conductive tubing, such as copper tubing. The larger heat affected zone enables the copper to retain uniform tensile strength across the welded joint. It should be readily apparent that the protrusions could take other configurations without departing from the spirit and scope of the present invention. For example, each collet member could include one protrusion, or three or more protrusions 25. Also, the protrusions 25 could be constructed from a different material than the collet members 48, 50 and attached to the collet members by fasteners or any other suitable means (not shown). Such an arrangement may provide an improved gripping surface for the work piece, a reduction in thermal conductivity for the work piece holders, and/or adaptability of the collet members to accommodate work pieces of different sizes, while maintaining electrical conductivity between the work piece and the fixture.

Referring to FIG. 7, at the entrance end to collet member 48, there is a somewhat conical or tapered mouth portion 58 which is significantly wider. The mouth 58 may better accommodate work pieces including fitting bodies or forging bosses or any wider portion that extends radially from the portion of the work piece to be fixtured for welding.

The apparatus thus far described is capable of rigidly and tightly engaging the outside diameter (OD) surface of tubing or other cylindrical work pieces of a particular size depending on the diameter of the clamping surface 27. By changing the collet members 48, 50, that is, removing the collet members 48, 50 from the fixture 10 and replacing them with differently dimensioned collet members, the fixture 10 can be made to accommodate a variety of different tubing or other work piece sizes. Additionally, by changing the collet members in one unit 12 relative to those in the mating unit 14, it is possible to bring into alignment tubing or fittings or other work pieces 60 of different sizes such that it is possible to weld various tube and fitting combinations.

Commercially available tubing typically is manufactured to a nominal outer diameter which varies plus and minus depending on the tolerance range. In accordance with another aspect of the invention, the design of the subject collets is such as to compensate for these tolerance variations and permit the clamping units to firmly engage and positively hold the tubing sections irrespective of their particular variation within the accepted tolerance range.

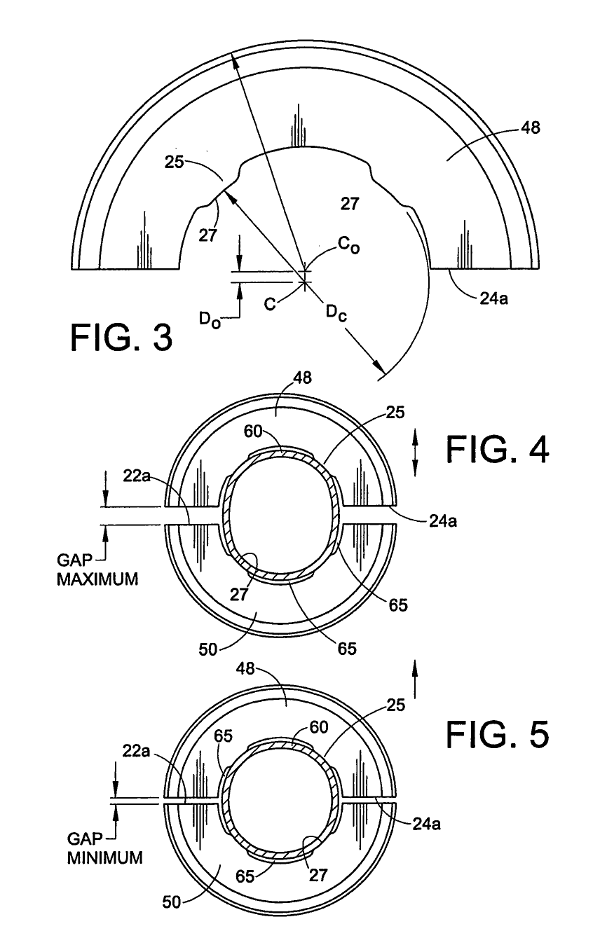

FIG. 3 is an enlarged elevational view of a collet member 48. In the exemplary embodiment, the work piece gripping surfaces 27 are formed with an arcuate contour defining a bore diameter which is equal to the maximum tubing diameter which is expected to be encountered for the nominal tubing size for which the collet is designed. That is, the surface 27 defines a bore having a diameter equal to the nominal tubing diameter plus the tolerance variation for that particular nominal diameter. For example, with one half inch nominal diameter tubing, a normal tolerance range is +/−0.005 inches, or a total tolerance of 0.010 inches. In this example, the clamping surface 27 is bored to a diameter of 0.505. Additionally, it should be noted that other tolerances related to the allowable variations in the collet member geometry and allowable variations in the holding or clamping mechanism geometry may affect the contact and resulting grip between the gripping surfaces 27 of the collet member 48 and the work piece 60. These tolerances may include, for example, deviations in the collet member thickness, or the offset of the gripping surface from the collet member outside diameter, deviations in the inside diameter of the clamp half 24, and deviations in the outside diameter of the collet member. To accommodate these tolerance variations, the center point C of the bore which defines the surface 27 (or the center point of the arcuate surface 27) in the exemplary embodiment is offset outwardly beyond a center point C₀ of the outside diameter of the collet member 48, as illustrated in FIG. 3. In an examplary embodiment, the center point C of the bore diameter Dc is offset from the center point C₀ of the collet member outside diameter Do. In the example, the offset is equal to half of the total of the tubing tolerance plus a tolerance for the collet member geometry variation, plus a tolerance for the clamping mechanism variation, plus a small offset to ensure a minimum amount of clamp force (or a small interference fit). Using nominal example tolerances for the example of one half inch nominal diameter tubing as described above, the distance the gripping surface center point may be offset from the collet member center point is approximately the sum of half of the total tolerance of the work piece or tubing diameter (half of 0.010 inches, or 0.005 inches), a collet member geometry tolerance of 0.00075 inches, a clamping mechanism geometry tolerance of 0.0005 inches, and an interference fit or clamping force offset of 0.00025 inches, for a total offset distance of 0.0065 inches beyond the collet member center point. This offset distance assures that each clamp half will be able to properly clamp even the smallest tubing within a normal tolerance range by providing at least minimal contact between the gripping surfaces 27 and the work piece 60. This is illustrated by FIGS. 4 and 5. However, it should be noted that the above offset formula defines a minimum offset that may be needed to ensure that all work pieces within tolerance may be properly clamped in the fixture. A collet member with an offset greater than the defined distance may also be used, and in some cases, a collet member with an offset less than the defined distance may be sufficient.

FIG. 4 illustrates a cylindrical work piece 60 which is clamped between the collet members 48 and 50. In the example of FIG. 4, the cylindrical work piece 60 is a tube. The tube in this illustration has the maximum outer diameter encountered for this particular nominal tubing size. That is, the tubing is at its maximum tolerance variation. In this instance, when the clamp halves 22 and 24 come together there is significant spacing or a gap, exaggerated in FIG. 4 for clarity, between the opposed collet faces 22a, 24a.

FIG. 5 illustrates the clamping function when the tubing 60 has a minimum outer diameter as dictated by the maximum tolerance variations in the negative direction (i.e., the smallest diameter tubing within standard tolerances). Specifically, the gap, exaggerated in FIG. 5 for clarity, between the collet members 48 and 50 is at a minimum. However, the collets firmly engage the outside diameter surface of the tube at the diametrically opposed protrusions 25. By offsetting the center of the work piece gripping surfaces 27 in the manner shown in FIG. 3, the collet properly engages a tube having the minimum tube outer diameter within the standard tolerances.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1. A fixture for clamping a cylindrical thermally conductive work piece, comprising:
a first collet member including a body and at least one work piece engaging protrusion; and
a second collet member including a body and at least one work piece engaging protrusion; wherein
the protrusions of both first and second collet members engage the work piece to clamp the work piece between the first collet member and the second collet member.

2. The fixture of claim 1, further comprising a clamping mechanism for urging the first collet member toward the second collet member.

3. The fixture of claim 1, wherein said protrusions limit surface contact between the work piece and the first and second collet member bodies.

4. The fixture of claim 1, wherein the at least one protrusion of the first collet member comprises feathered edges.

5. The fixture of claim 1, wherein the at least one protrusion of the first collet member defines a first work piece gripping surface and is contoured to provide substantially uniform contact between the first work piece gripping surface and a cylindrical work piece.

6. The fixture of claim 5, wherein the first work piece gripping surface is adapted to accommodate a maximum tolerance outer diameter of the cylindrical work piece.

7. The fixture of claim 1, further comprising opposing first and second collet faces, said first collet face proximate to said first collet member and said second collet face proximate to said second collet member, wherein the fixture is adapted to provide a gap between said first and second collet faces.

8. The fixture of claim 1, wherein the first collet member has an outside diameter defining a collet member center point and the at least one protrusion of the first collet member defines an arcuate work piece gripping surface having a center point that is offset beyond the collet member center point.

9. The fixture of claim 8, wherein the distance the gripping surface center point is offset from the collet member center point is greater than half of a total tolerance of an outside diameter of the work piece.

10. The fixture of claim 1, wherein said collet members are releasably connected to said fixture.

11. A method of clamping a cylindrical thermally conductive work piece, comprising:
placing the cylindrical thermally conductive work piece between a body of a first collet member and a body of a second collet member; and
urging the first collet member toward the second collet member, such that at least one protrusion defined by the first collet member and at least one protrusion defined by the second collet member engage the work piece to clamp the work piece between the first collet member and the second collet member.

12. The method of claim 11, wherein said protrusions provide spaces between the work piece and said collet member bodies to limit heat transfer between the work piece and said collet member bodies.

13. A method of welding a cylindrical thermally conductive work piece, comprising:
placing the cylindrical thermally conductive work piece between a body of a first collet member and a body of a second collet member;
urging the first collet member toward the second collet member, such that at least one protrusion defined by the first collet member and at least one protrusion defined by the second collet member engage the work piece to clamp the work piece between the first collet member and the second collet member;
applying an inert gas to the work piece, wherein a portion of the inert gas flows through gaps between the protrusions; and
welding the work piece.

14. The method of claim 13, wherein said gaps between the protrusions limit heat transfer between the work piece and said collet member bodies.

15. A collet member for holding a cylindrical thermally conductive work piece, comprising: a body that defines a work piece opening and at least one work piece engaging protrusion for engaging the work piece when the work piece is disposed in the work piece opening, wherein the at least one protrusion limits contact between the body and the work piece to reduce heat transfer between the work piece and the collet member.

16. The collet member of claim 15, wherein the at least one protrusion defines a work piece gripping surface and is contoured to provide substantially uniform contact between the work piece gripping surface and a cylindrical work piece.

17. The collet member of claim 16, wherein the work piece gripping surface is adapted to accommodate a maximum tolerance outer diameter of the cylindrical work piece.

18. A collet member for holding a cylindrical thermally conductive work piece, comprising: a body that defines a work piece opening and a work piece engaging surface for engaging the work piece when the work piece is disposed in the work piece opening, wherein one or more hollow regions are defined by the body to reduce the mass of the collet member.

19. The collet member of claim 18, wherein the one or more hollow regions define first and second end walls.

20. The collet member of claim 19, wherein the first and second end walls each include at least one work piece engaging protrusion which define the work piece engaging surface.

21. The collet member of claim 19, wherein the first end wall defines a tapered mouth portion adapted to accommodate a wider portion of the work piece.

22. A welding assembly, comprising:
a welder;
a fixture comprising a collet member for positioning a cylindrical thermally conductive cylindrical work piece with respect to the welder, wherein the collet member includes a body and at least one work piece engaging protrusion for engaging the work piece to hold the work piece in the fixture.

23. The welding assembly of claim 22, wherein the at least one protrusion limits contact between the collet member body and the work piece to reduce heat transfer between the work piece and the collet member.
